(19) United States
(12) Patent Application Publication
(10) Pub. No.: US 2010/0149817 A1
(43) Pub. Date: Jun. 17, 2010

(54) EASILY REPLACEABLE LAMP CARTRIDGE WITH INTEGRATED SLIT APERTURE AND COOLING ELEMENT

(75) Inventors: Nicholas B. MacKinnon, Vancouver (CA); Ulrich Stange, Vancouver (CA); Water Caldwell, Thousand Oaks, CA (US)

Correspondence Address: GRAYBEAL JACKSON LLP, 400 - 108TH AVENUE NE, SUITE 700, BELLEVUE, WA, 98004, US

(73) Assignee: TIDAL PHOTONICS, INC., Vancouver, BC (CA)

(21) Appl. No.: 12/521,738

(22) PCT Filed: Dec. 28, 2007
(86) PCT No.: PCT/US2007/026454

§ 371 Date: Jan. 4, 2010

Related U.S. Application Data
(60) Provisional application No. 60/877,808, filed on Dec. 29, 2006.

(51) Int. Cl. F21V 29/00; F21S 6/00; F21V 3/02; H01J 9/24; H01J 9/50

(52) U.S. Cl. 362/294; 362/311.01; 362/311.06; 445/23; 445/2

(57) ABSTRACT

An easily replaceable lamp cartridge system that provides a narrow line of light and that can be placed into an optical path of an instrument or optical system. The cartridge comprises an integrated lamp, at least one focusing element, cooling components and at least one slit aperture mounted in a housing typically comprising mechanical indexing features and connectors to facilitate easy placement and replacement.

### CROSS-REFERENCE TO RELATED APPLICATIONS

The present application claims priority from U.S. provisional patent application Ser. No. 60/877,808, filed 29 Dec. 2006, which is incorporated herein by reference in its entirety and for all its teachings and disclosures.

### BACKGROUND

Instruments used to create or project light often employ lamps that need to be replaced over time. Lamps sometimes fail suddenly as when the filament in a household lamp burns out, and sometimes slowly as light output drops over time. Lamps that are incorporated in instruments sometimes have significant cooling requirements and may be incorporated in complicated structures that make replacement difficult. Lamps also may incorporate optical components such as parabolic or elliptical reflectors for directing light. Sometimes these optical components need to be aligned with other optical paths or optical components in the instruments.

In some instruments such as slit lamps used for examining the eye, or light sources incorporating wavelength dispersive devices such as prisms or diffraction gratings to select particular wavelengths, slits are employed to create a narrow line of light. In this case the alignment of the light source so that maximum energy is focused through the slit is important. This complicates lamp replacement since alignment of the slit and lamp is typically desired.

In some applications the slits are placed at the focus of intense light energy which can cause melting or thermal breakdown of the slits.

In wavelength dispersive devices the width of the slit also determines the degree to which wavelengths can be separated. Narrower slits produce superior wavelength selection and wavelength resolution but at the price of reduced energy throughput. Wider slits provide higher energy but less wavelength resolution.

A variety of approaches have been pursued to remedy these problems, particularly as devices such as digital projectors and rear projection televisions have become consumer products. Lamp cartridges with alignment and indexing features have been developed to position lamps on an optical axis. Other lamp cartridges have been developed that incorporate heat dissipative elements such as cooling vanes and in some cases cooling fans. Until recently illumination systems employing wavelength dispersive elements were not commonly produced and were used in more technical applications where operators replacing lamps possessed skill and training in alignment. With the more recent development of digital illumination systems designed for a wide range of uses there has gone unmet a need for easily replaceable lamp cartridges that provide lamps with pre-aligned integral slits to simplify lamp replacement. The present devices, systems, methods, etc., provide these and other advantages.

### SUMMARY

In one aspect, the present devices, systems, methods, etc., provide a lamp cartridge that incorporates a lamp (light source) with at least one focusing element(s) such as lenses or integral reflectors for directing light from the lamp as a focused beam, optional cooling elements to dissipate heat from the lamp, and a slit disposed at the focus of the lamp (and therefore the focusing element) to provide a narrow line of light that can be subsequently projected through an optical system or instrument. All of desired elements are incorporated in at least one housing or other container/enclosure to form a cartridge that facilitates and simplifies replacement of failed or aging lamps by the user of the optical system or instrument in a modular manner.

Exemplary light sources, wavelength dispersive devices, illumination systems, etc., that can be useful for the aspects and embodiments discussed herein can be found, for example, in U.S. Pat. Nos. 6,721,471; 6,961,461; 6,781,691; 7,151,601; and, US patent publication nos. US20020180973 A1; US20050234302; US20050063079 A1; US20050213181; US20050228231; US20050251230; and US20050213092. As noted elsewhere herein, all such references are incorporated herein by reference in their entirety and for all their teachings and disclosures.

In a further aspect, the present devices, systems, methods, etc., provide cartridge system wherein at least one cartridge comprises a lamp with at least one focusing element, optional cooling elements, and a slit. Where more than one cartridge is used, such can be implemented in discrete fashion such that the illumination system configured to hold the cartridges is further configured such that the cartridges are pre-aligned such that the light from the lamp is substantially transmitted downstream to the slit with minimal loss of power.

In another aspect the lamp cartridge incorporates a cooling fan to provide a flow of air to cool the cartridge. Light focused onto a slit can generate intense amounts of energy which is typically preferably removed to inhibit damage due to melting or failure of the slit due to expansion or contraction.

A further aspect provides a lamp cartridge with a slit with heat removal features that take advantage of combined cooling systems used to dissipate excess energy from the lamp and the slit. In yet another aspect the lamp cartridge provides slits of different widths so that in wavelength dispersive instruments, the wavelength resolution can be changed as needed by replacing the lamp cartridge.

In another aspect the lamp cartridge provides indexing points and reference surfaces to simplify installation and alignment of the cartridge to the optical system of the instrument in which the cartridge is placed.

In another aspect the cartridge provides electrical connectors that facilitate the connection of the lamp cartridge to the electrical system of the instrument in which the cartridge is to be placed. These connectors may be integral to the housing or they may be in the form of a wiring harness and connector system.

In these and other aspects, unless expressly stated otherwise or clear from the context, all embodiments of the present invention can be mixed and matched.

These and other aspects, features and embodiments of the present invention are set forth within this application, including the following Detailed Description and attached drawings. In addition, various references are set forth herein, including in the Cross-Reference To Related Applications, that describe in more detail certain apparatus, methods and other information; all such references are incorporated herein by reference in their entirety and for all their teachings and disclosures, regardless of where they may appear in this application.

### BRIEF DESCRIPTION OF THE DRAWINGS

FIG. 1 shows a front plan view of a lamp cartridge system looking along the axis of projection of the lamp at the slit aperture.

FIG. 2 shows a side plan view of an exemplary lamp cartridge system as discussed herein.

FIG. 3 shows a cross-sectional view of an exemplary lamp cartridge system as discussed herein.

FIG. 4 shows a cross-sectional view of another embodiment of a lamp cartridge system as discussed herein.

FIG. 5 shows a perspective view an exemplary lamp cartridge system as discussed herein.

FIG. 6 shows a top plan view of a lamp cartridge system as discussed herein.

FIG. 7 shows a top plan view of an illumination system containing a replaceable lamp cartridge system as discussed herein.

FIGS. 8A and B depicts a side plan view of a lamp aperture assembly where at least one surface facing the focused light beam is shaped to reduce or prevent mirroring or specular reflection back to the lamp.

FIG. 9 is a side plan showing an exemplary lamp cartridge with mating connectors.

### DETAILED DESCRIPTION

The present devices, systems, methods, etc., provide an easily removable lamp cartridge incorporating a light source, a focusing element and a pre-aligned slit-type aperture wherein the cartridge can be easily removably mounted in an instrument and can be easily replaced as the lamp power drops or the lamp fails to operate or for any other reason the lamp is no longer satisfactory.

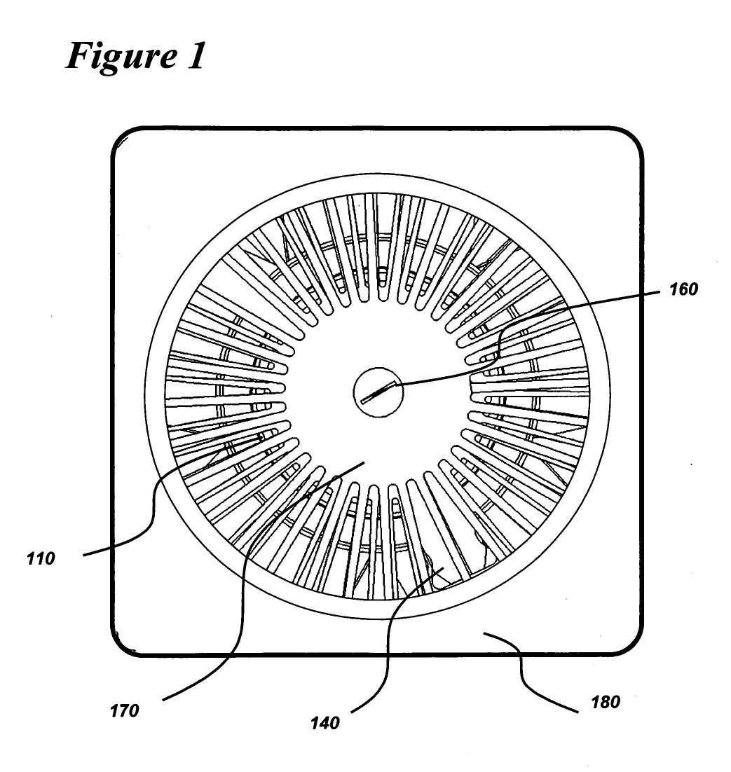

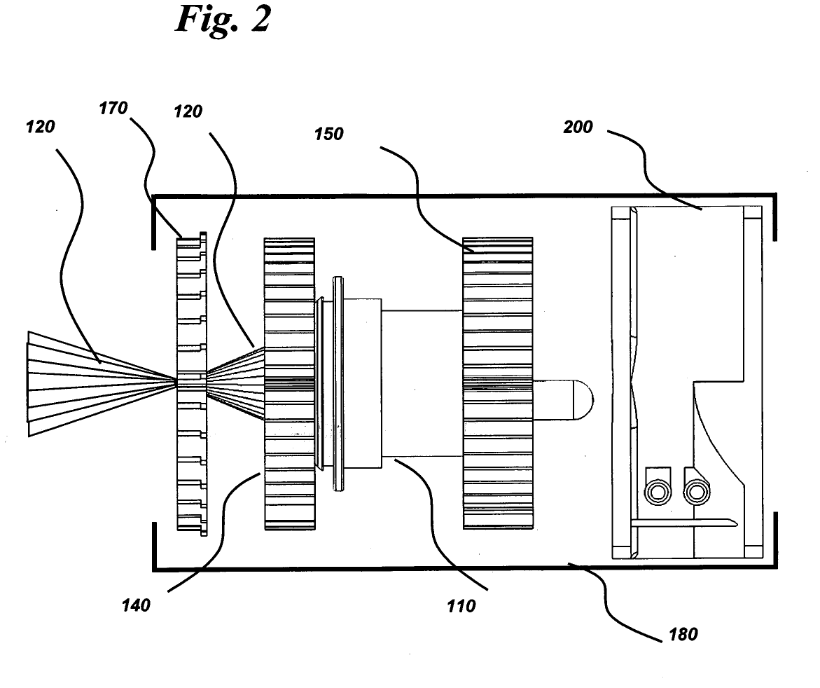

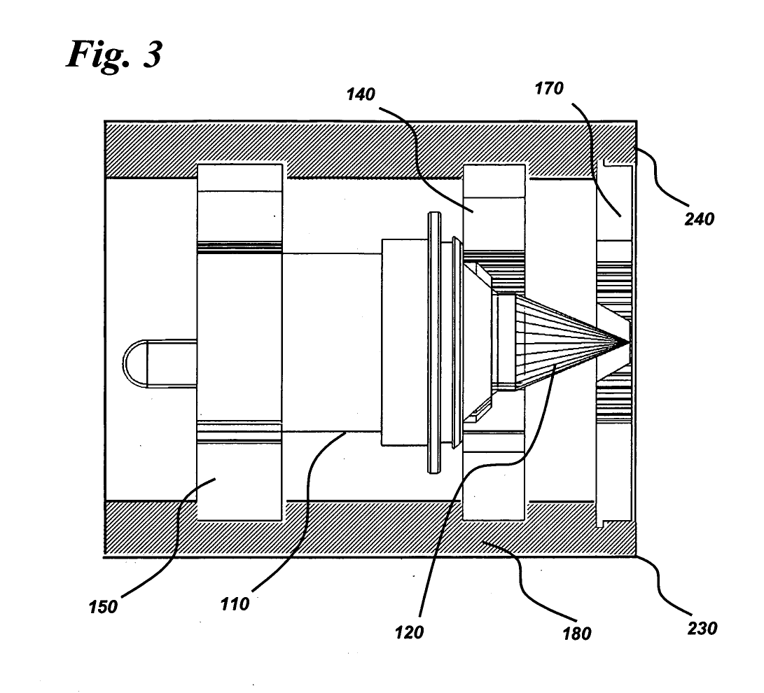

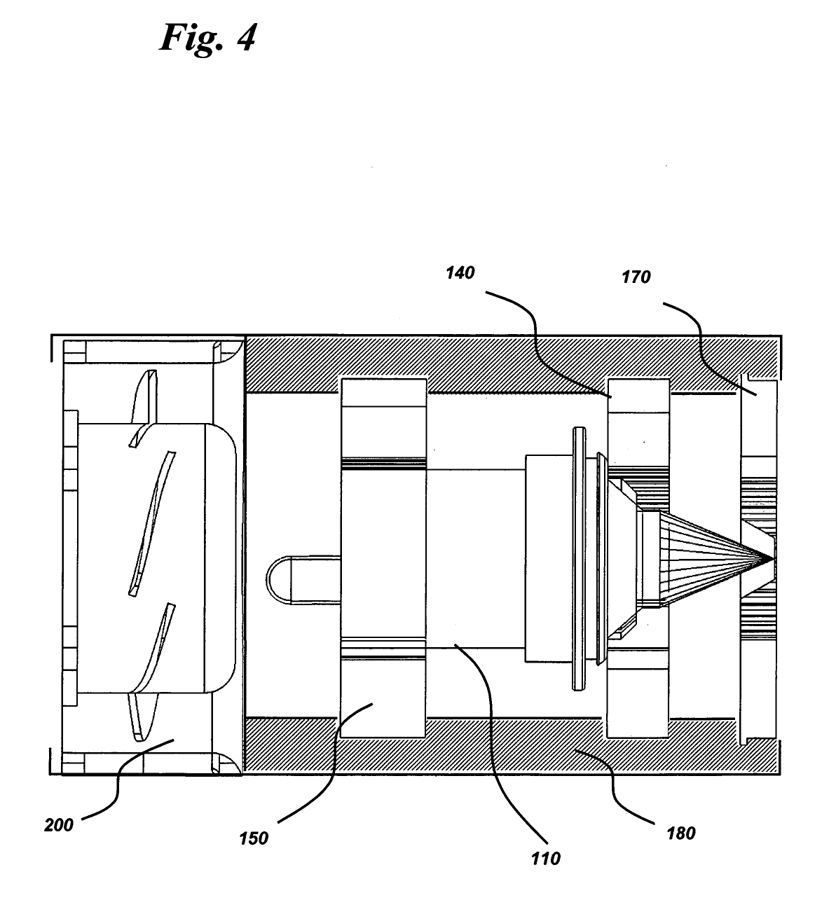

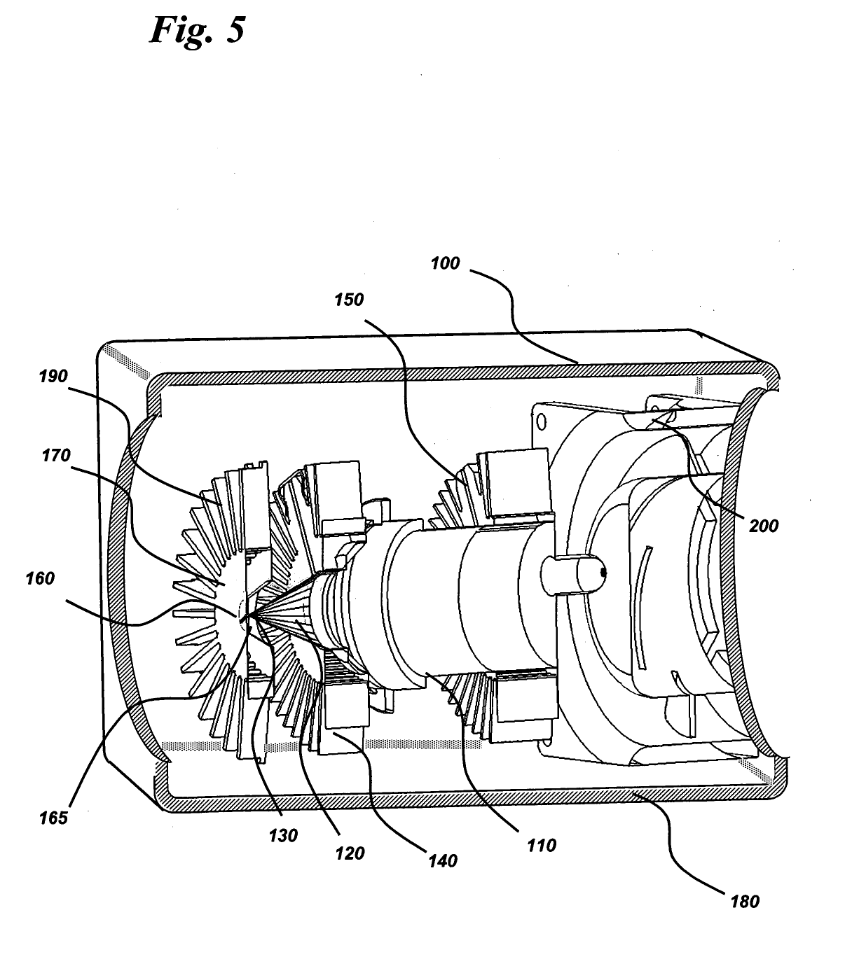

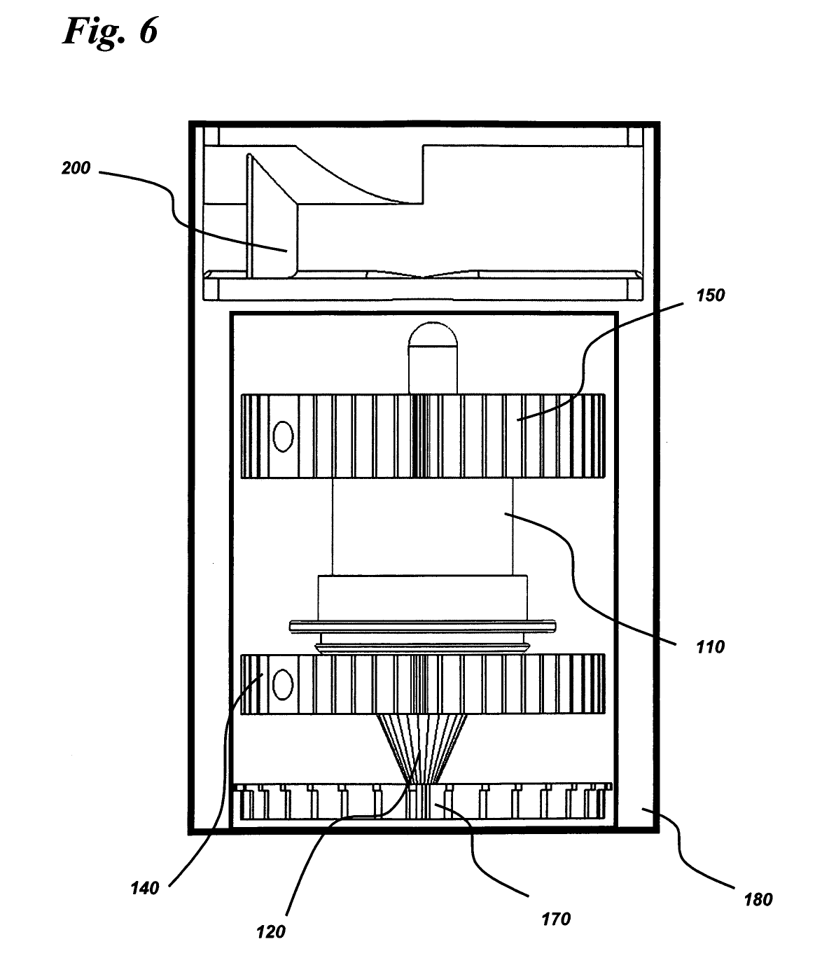

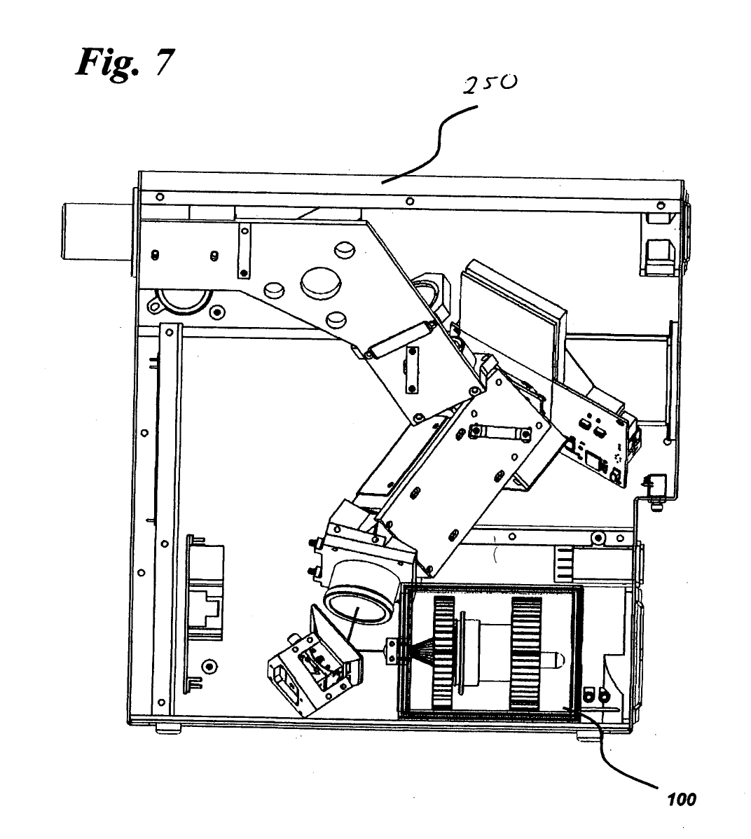

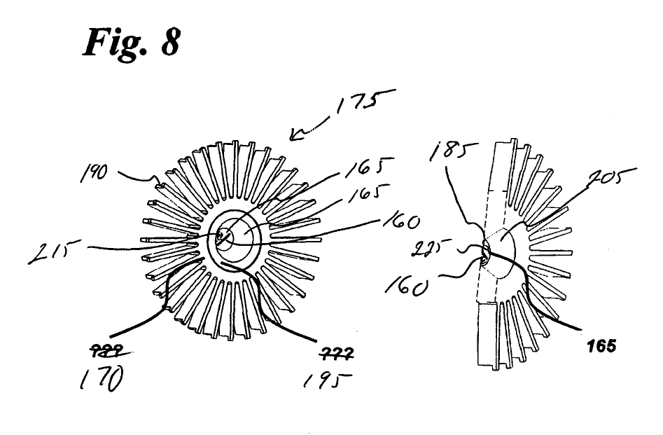

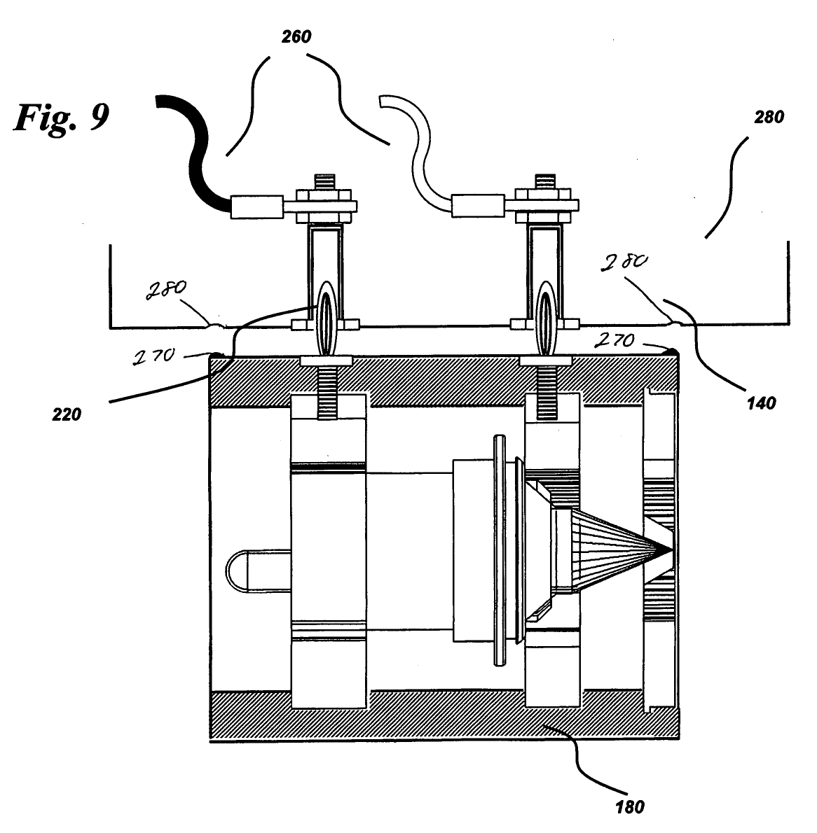

The Figures use the same reference numerals for the various elements of the exemplary embodiments depicted within the Figures. FIG. 1 is a drawing showing a front plan view of a lamp cartridge system looking along the axis of projection of the lamp at the slit aperture. FIG. 2 shows a side plan view of a lamp cartridge system showing a lamp, cooling fan, lamp cooling heat exchangers and the slit with its cooling heat exchanger. FIG. 3 shows a cross-sectional view of a lamp cartridge system without an integral cooling fan and showing a lamp, lamp cooling heat exchangers and the slit with its cooling heat exchanger and illustrating how the light from the lamp is focused on the slit aperture. FIG. 4 shows a cross-sectional view of a lamp cartridge system with an integral cooling fan showing the lamp, lamp cooling heat exchangers and the slit with its cooling heat exchanger and illustrating how the light from the lamp is focused on the slit aperture. FIG. 5 shows a perspective, cross-sectional view of a lamp cartridge system with an integral cooling fan showing the lamp, lamp cooling heat exchangers and the slit with its cooling heat exchanger and illustrating how the light from the lamp is focused on the slit aperture. FIG. 6 shows a top plan view of a lamp cartridge system with an integral cooling fan showing the lamp, lamp cooling heat exchangers and the slit with its cooling heat exchanger and illustrating how the light from the lamp is focused on the slit aperture. FIG. 7 shows a top plan view of scientific instrument comprising an illumination system containing a replaceable lamp cartridge system as discussed herein. In this embodiment, the illumination system is a light engine using light from the replaceable lamp cartridge to provide any desired composition of wavelengths and/or wavelengths intensities desired by the user up to the limits of the light from the lamp in the replaceable lamp cartridge. See, e.g., U.S. Pat. No. 6,781,691. FIGS. 8A and B depict a lamp aperture component or assembly from the replaceable lamp cartridge, the surface of the assembly facing the focused beam of light shaped to reduce or prevent mirroring or specular reflection back to the lamp. FIG. 9 shows an exemplary lamp cartridge with mating connectors.

The perspective view in FIG. 5 shows various elements of the embodiments in a possibly more easily understood view than some of the other figures and thus will be first discussed in somewhat more detail. In FIG. 5, replaceable lamp cartridge 100 comprises an lamp 110 that can be an arc lamp configured with a reflector to focus emanating light 120 from the arc to a focal point 130, electrically and thermally conductive electrodes such as cathode 140 and anode 150 that provide electrical power to the arc lamp and in some aspects can also serve as heat exchangers to facilitate cooling of the lamp. Positioned at the focal point 130 of the lamp is slit 160 that limits light exiting from the replaceable lamp cartridge 100 to light that can pass through the slit 160. In one embodiment, slit 160 is formed in a cooling vane assembly 170 comprised of a highly thermally conductive material such as highly thermally conductive ceramic or highly thermally conductive metal such as copper or aluminum that can facilitate dissipation of the intense heat produced at the focus of the arc. Arc lamp 110, cathode 140, anode 150, slit 160 and cooling vane assembly 170 are disposed within a lamp cartridge enclosure 180.

Arc lamps are well known and can be purchased from manufacturers such as PerkinElmer (Freemont, Calif.) or Osram (Munich, Germany). Arc lamps can be purchased with or without integral reflectors and with several types of fill gases including xenon or mercury or with other metals or halogen elements.

One embodiment comprises high pressure xenon filled arc lamps similar to the Cermax™ brand (PerkinElmer, Fremont Calif.) that provide illumination with a relatively continuous wavelength spectrum. Another embodiment comprises ultra high-pressure mercury lamps similar to the Osram HXP-R-120-45C that provide an illumination spectrum with a number of intense peaks at certain wavelengths. These lamps both produce a focused beam of light and can be mounted in the housing and disposed so that the focal point of the beam 130 is directed to focus on slit 160.

The preceding lamps both have integral reflectors, but the lamp cartridge can also comprise arc lamps without integral reflectors (similar to the Osram XBO 100), and/or where the reflector is a separate element mounted in the cartridge that can direct light emitted by the arc lamp to a first or second focal point. Typically this will be an ellipsoidal reflector with the arc of the arc lamp disposed at one focus of the ellipsoid and the second focus 130 disposed at the slit 160 of slit 160 and cooling vane assembly 170. Such ellipsoidal reflectors well known and are commercially available from companies such as Melles-Griot (Carlsbad, Calif.).

In one embodiment the lamp cartridge enclosure 180 comprises a plastic enclosure that acts as an electrical insulator and holds the lamp, electrodes, and slit 160 assembly in pre-aligned relation to one another, so that the focused light from the lamp is directed to the slit 160. The lamp cartridge enclosure 180 may also be formed from a ceramic or other suitable material, typically a non-conductive material, that provides electrical insulation. As shown in FIG. 9, the lamp cartridge enclosure 180 can further comprise mating type connectors 220 to facilitate easy connection of the lamp electrodes to the electrical systems of the instrument with which it will be used. The lamp cartridge enclosure 180 can also provides mounting and indexing points 270, 280 or planes that allow it to be mounted into the instrument in which it will be used in a fixed orientation so that it can effectively direct light into the instrument optical systems. Indexing points 270, 280 or planes comprise physical features of the lamp cartridge housing that mate to physical features of the instrument lamp cartridge mounting bay that ensure that the slit 160 element of the lamp cartridge is placed in a predefined position relative to the instrument optical path. In one embodiment, the indexing planes are at least one of the front, side, top or bottom of the enclosure 180. The front of the enclosure 180 is the portion of the lamp cartridge enclosure 180 from which the desired light is emitted. In another preferred embodiment the indexing points are corners cast, machined or otherwise formed into the lamp cartridge enclosure 180. In a further embodiment the indexing points are pins that fit to matching receptacles on one or more sides of the lamp cartridge enclosure 180 and the instrument. Either the pins or the receptacles may be disposed on the lamp cartridge enclosure 180. The lamp cartridge enclosure 180 can also comprise adjusters that can be used to position the elements within the cartridge assembly for optimal output of illumination through the slit 160.

In one embodiment that incorporates a cylindrical high-pressure ceramic xenon arc lamp with integral reflector, the anode and cathode of the lamp are mounted in anode and cathode electrode assemblies 140, 150 that comprise electrically and thermally conductive heat exchangers. Anode and cathode heat exchangers 140, 150 and slit 160 and cooling vane assembly 170 typically comprise a highly thermally conductive material such as copper or aluminum that can be cast, extruded, machined, or constructed by folding and welding or brazing sheet metal to provide concentrically arranged cooling vanes 190 that conduct heat away from the lamp. The cooling vanes 190 can operate in conjunction with an air circulation system 200 that draws air through the lamp cartridge assembly and pulls air through and across the cooling vanes. The air circulation system 200 is typically an air fan that may be located near to or remote from the lamp cartridge assembly or in some embodiments may be incorporated as part of the lamp cartridge assembly. In one embodiment the cooling fan 200 is a permanent part of the instrument that accepts the lamp cartridge and the lamp cartridge enclosure 180 is shaped to match the aperture of the fan 200, which is mounted immediately behind the lamp cartridge assembly, and pulls air through the assembly over and around the cooling vanes of the slit 160 assembly and the electrodes. In another embodiment the lamp cartridge housing 180 is shaped to match a duct that is connected to a fan which may be near to or distant from the lamp assembly. In still another embodiment, the replaceable lamp cartridge 100 contains the fan, which as shown for example in FIG. 7 is placed/replaced in the illumination system 250 with the other components of the replaceable lamp cartridge 100.

In one embodiment the slit 160 and cooling vane assembly 170 is mounted in the enclosure 180 near the front of the lamp 110 with the slit 160 substantially at the focus of the lamp. The slit 160 may be rotated or translated around the axis of illumination to improve the throughput of the lamp and to orient the line of light so that the so that the angle of the slit 160 matches the needs of the instrument. In one embodiment, as depicted in FIG. 7 the illumination system 250 or device containing the replaceable lamp cartridge 100 is an instrument comprising a wavelength dispersive device used as a spectrum former. In this case the width of the slit 160 impacts how well the wavelengths of light so dispersed can be resolved. A narrow slit 160 produces high resolution and a correspondingly better ability to select specific wavelengths for specific uses. A narrow slit 160, however, also reduces the overall optical throughput of the system since it restricts the amount of light through the system. In some cases it is desirable to have better resolution, while in other cases higher a brighter output is desirable. For this reason it is desirable to have lamp cartridges that can be easily replaced and that have different slit 160 widths allowing the user to change the performance characteristics for the instrument to suit the user's needs, and/or to have a slit that is variable in width within a single cartridge. In certain spectrally dispersive systems it is size of the optical image of the slit 160 at the spectrum-forming plane that determines the resolution.

A lamp cartridge where slit 160 is machined or otherwise configured such that the image of the slit 160 produces a spectral band that can be resolved to less than 20 nm is a particularly useful range of resolution. Multiple cartridges/variable slits sized to provide discrete resolutions of 5 nm, 10 nm, and 15 nm are also particularly useful.

A problem with a lamp cartridge incorporating a slit 160 aperture is that much of the energy in the cone of light focused by the lamp may not pass through the slit 160 and into the optical system. This energy should be safely dissipated. If it reflects back into the lamp it can cause localized overheating that results in unstable lamp operation, premature failure or explosion hazard. It is well known that a mirror placed at the focus of an illumination system will reflect light back along its original optical path. If the high intensity light from the arc lamp is reflected back to its source it can overwhelm the ability of the electrodes at the arc to conduct heat away. FIGS. 8A and B depict an exemplary embodiments in which a portion of the lamp aperture assembly 175 (which in the embodiment depicted is a cooling vane assembly 170 comprising an inner structure 195 comprising slit 160) facing the focused beam of light comprises at least one surface 165 shaped to reduce or prevent mirroring or specular reflection back to the lamp. In one embodiment surface 165 is an elongated quasi-conical (e.g., frustoconical) cavity with its apex 185 containing slit 160 and its sides 205 angled so that reflection of light not entering the slit 160 is directed in a way that will not reflect or otherwise transmit the undesired energy back to the lamp nor other undesired location. In another embodiment surface 165 is pitted or pebbled 215 to provide a diffuse reflection of the undesired energy. In another embodiment surface 165 is a dome and/or grooved with concentric or linear grooves 225 to provide a diffuse reflection of the undesired energy.

FIG. 9 depicts an embodiment wherein the lamp cartridge enclosure 180 comprises a plastic enclosure that acts as an electrical insulator and holds the lamp, electrodes, and slit 160 in pre-aligned relation to one another, so that the focused light from the lamp is directed to the slit 160. The lamp cartridge enclosure 180 may also be formed from a ceramic or other suitable material, typically a non-conductive material, that provides electrical insulation. The lamp cartridge enclosure 180 further comprises mating type connectors 220 to facilitate easy connection of the lamp electrodes to the electrical systems 260 of the instrument 280 with which it will be used. The lamp cartridge enclosure 180 can also provides mounting and indexing points 230 or planes 240 that allow it to be mounted into the instrument in which it will be used in a fixed orientation so that it can effectively direct light into the instrument optical systems. Indexing points or planes comprise physical features of the lamp cartridge housing that mate to physical features of the instrument lamp cartridge mounting bay that ensure that the slit 160 element of the lamp cartridge is placed in a predefined position relative to the instrument optical path. In one embodiment, the indexing planes are at least one of the front, side, top or bottom of the enclosure 180. The front of the enclosure 180 is the portion of the lamp cartridge enclosure 180 from which the desired light is emitted. In another preferred embodiment the indexing points are corners cast, machined or otherwise formed into the lamp cartridge enclosure 180. In a further embodiment the indexing points are pins that fit to matching receptacles on one or more sides of the lamp cartridge enclosure 180 and the instrument. Either the pins or the receptacles may be disposed on the lamp cartridge enclosure 180. The lamp cartridge enclosure 180 can also comprise adjusters that can be used to position the elements within the cartridge assembly for optimal output of illumination through the slit 160.

All terms used herein are used in accordance with their ordinary meanings unless the context or definition clearly indicates otherwise. Also unless indicated otherwise, except within the claims, the use of “or” includes “and” and vice-versa. Non-limiting terms are not to be construed as limiting unless expressly stated (for example, “including” and “comprising” mean “including without limitation” unless expressly stated otherwise).

Unless otherwise defined in the text, terms relating to measurement and characterization of light are used in their traditional context, for example as set forth in the Handbook of Optics, CD-ROM Second Edition, sponsored by the Optical Society of America and published by McGraw-Hill, 1996.

The figures depict representative examples of the present invention.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “means” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion herein.

1. A lamp cartridge for an illumination system, the lamp cartridge comprising a light source, at least one focusing element operatively connected to the light source to provide focused light from the light source at a focal point, and a pre-aligned slit located substantially at the focal point and configured to transmit a substantially focused line of light from the focused light from the light source to the illumination system, wherein the light source, focusing element, and pre-aligned slit are contained within a single enclosure that is sized and configured to be easily removably placed in an illumination system to provide a pre-aligned, substantially focused line of light from the light source for use within the illumination system.

2. The lamp cartridge of claim 1 wherein the cartridge further comprises at least one cooling element configured to dissipate heat from the light source.

3. The lamp cartridge of claim 2 wherein the cooling element is a cooling fan.

4. The lamp cartridge of claim 1, wherein the enclosure is a unitary housing.

5. The lamp cartridge of claim 1 wherein the cartridge is a replacement cartridge configured to replace an original equipment lamp system provided with the illumination system.

6. The lamp cartridge of claim 1 wherein the illumination system is a scientific instrument.

7. The lamp cartridge of claim 1 wherein the illumination system is a light engine using light from the replaceable lamp cartridge to provide any desired composition of wavelengths and/or wavelengths intensities desired by the user up to the limits of the light from the lamp in the replaceable lamp cartridge.

8. The lamp cartridge of claim 1 wherein the cartridge is configured to be operably disposed as one of a series of replaceable lamp cartridges.

9. The lamp cartridge of claim 1 wherein the lamp cartridge is one of a plurality of lamp cartridges comprising the elements of any one of claims 1 to 8 wherein each of the plurality of lamp cartridges comprises a slit of a different width.

10. The lamp cartridge of claim 1 wherein at least one of the lamp cartridge and the illumination system comprise at least one of indexing points and reference surfaces configured to simplify installation and alignment of the cartridge within the illumination system.

11. The lamp cartridge of claim 1 wherein the cartridge comprises electrical connectors that automatically operably connect the lamp cartridge to an electrical system of the illumination system upon placement of the lamp cartridge in the illumination system.

12. The lamp cartridge of claim 11 wherein the electrical connectors are at least one of integral to the housing or a wiring harness and connector system.

13. The lamp cartridge of claim 1 wherein the slit is formed in a dome configured and located such that the dome substantially does not reflect light back to the light source.

14. The lamp cartridge of claim 1 wherein a slit assembly comprising the slit comprises at least one of a highly thermally-conductive ceramic, or a highly thermally conductive metal.

15. The lamp cartridge of claim 1 wherein the thermally conductive metal is at least one of copper and aluminum.

16. The lamp cartridge of claim 1 wherein a portion of a lamp aperture component containing the slit and facing the focusing element comprises a surface shaped to reduce mirroring or specular reflection back to the lamp.

17. The lamp cartridge of claim 17 wherein the surface comprises at least one of an elongated quasi-conical cavity with its apex at the slit, pits or pebbling, or grooves.

18. A method of making an easily replaceable lamp for an illumination system, comprising:
a) providing an enclosure sized and configured to hold a light source, a focusing element and a pre-aligned slit aperture; the enclosure also sized and configured to be easily placed or replaced into the illumination system; and,
b) placing in the enclosure the light source, focusing element and pre-aligned slit aperture such that the focusing element focuses light from the light source to a focal point located at the pre-aligned slit to provide a pre-aligned, substantially focused line of light from the light source for use within the illumination system.

19. The method of claim 18 wherein the method further comprises providing at least one cooling element configured to remove heat generated by the light source from the cartridge.

20. A method replacing a light source for an illumination system, comprising:
a) removing an existing light source in the illumination system; and,
b) providing a lamp cartridge according to claim 1 and placing the lamp cartridge in the illumination system without separately aligning any of the light source, the focusing element and the slit after the cartridge has been inserted into the illumination system.
